(19) United States
(12) Patent Application Publication
(10) Pub. No.: US 2011/0036421 A1
(43) Pub. Date: Feb. 17, 2011

(54) Propane tank safety device

(76) Inventors: Franklin D. Minnella, Corona, CA (US); Ming-Liang Shiao, Anaheim, CA (US)

Correspondence Address: David L. Bell, Esq., 2214-A Gates Avenue, Redondo Beach, CA, 90278, US

(21) Appl. No.: 12/583,282

(22) Filed: Aug. 17, 2009

(51) Int. Cl. F16K 27/08

(52) U.S. Cl. 137/382

(57) ABSTRACT

A propane tank safety device and a method are provided which permit service personnel or others to easily install the device on a tank such as a propane tank. In the preferred embodiment, the device includes a male protective cap and a female receiver that cooperate together to block and lock an outlet stem of a tank service valve. The protective cap comprises a stem attached to a dome. Housed within the protective cap is a lock such as a plug cylinder lock. The lock includes a latch that, in the extended and locked position, protrudes outwardly from the stem. The bottom surface of the dome of the protective cap has a longitudinally extending lip that is shaped to completely cover a top surface of the receiver. The receiver has a top and a bottom and a longitudinally extending bore therein opening to the top, an interior surface and an exterior surface. The exterior surface is partially threaded to match the ASME standard thread used in the outlet stem of a propane tank valve. The interior surface of the receptor forms the walls of the bore and has a ridge extending radially towards the center to receive the latch of the lock housed within the protective cap. In a second embodiment, the bore of the receptor has a groove extending throughout the circumference of the interior surface of the receptor. The groove is large enough and deep enough to receive the latch. The ridge or groove cooperates with the latch to prevent the locked device from being withdrawn from the outlet stem.

### BACKGROUND OF THE INVENTION

1. Field of the Invention

The present invention is directed toward the field of propane tanks and more particularly towards a propane tank safety device. The particular methods and apparatus described herein relate to the protection of propane tanks and their contents. However, the invention as described more fully below is not limited to this particular application or use and the invention is not intended to be limited to this particular use.

2. Background of the Invention

Standard propane tanks range in size from 5 gallons to 1,000 gallons and are designed to hold liquid propane gas. The five gallon tanks are often used for barbeque grills and are perhaps most familiar to the consumer. Slightly larger tanks are used for recreational vehicles. Even larger tanks are used in rural areas for home heating and cooking. Regardless of the size of the tank, it must be constructed according to standards established by the ASME (American Society of Mechanical Engineers). Additionally, all tanks contain at least one propane service valve that includes an outlet stem onto which a pipe or hose can be attached to supply liquid propane to a downstream appliance. Most propane tanks use a standard configuration service valve.

The propane tank service valve is the controlling mechanism allowing propane gas to flow into an appliance, house or building by way of a gas piping system. Although other gas valves may be present throughout the system, the service valve on the propane tank is the valve that controls the gas flow into the gas system. Basically, propane service valve functions as the “on/off switch” in propane gas systems. The operation of a propane tank service valve is similar to that of a water faucet. The operational part of the valve consists of a handwheel that closes and opens gas flow by turning the wheel clockwise and counter-clockwise. The valve includes an outlet stem and seat that when opened, allows gas to exit the tank and when closed, stops the flow of gas. The hose end connection on either a fill hose or appliance supply line is designed to connect to the outlet stem of the propane tank service valve. The hose end connection fitting is surrounded by ACME standard threads that cooperate with reverse-threaded threads on the interior surface of the outlet stem to form a tightly sealed connection between the tank and a downstream appliance.

Because of the large capacity of some tanks and the rising cost of petroleum products, a problem of content theft can arise on propane tanks. For the past forty years, the only available theft deterrent on the market has been a plug that screws into the outlet stem of the propane tank to block the propane gas passageway. The plugs are generally described in U.S. Pat. No. 6,029,683 by Moebs, et al. The plug and the outlet stem are reverse-threaded (also called left-hand threading). That means that the plug must be rotated in a counter-clockwise direction to be screwed in and rotated in a clockwise direction to be unscrewed. The plug did not traditionally contain a locking mechanism. Security was provided by hoping that the vandal or thief would try to unscrew the plug in a normal direction and would not realize that the plug must be unscrewed in a reverse direction. Ultimately, it was hoped, the vandal would give up trying to unscrew the plug and leave. For those who were familiar with the operation of the propane tank plug, this device provided virtually no protection against theft of the contents. For the past forty years, no security device entered the market place to replace or improve the plug until 2004.

A protective device for a propane tank is illustrated in U.S. application Ser. No. 10/806,873 (the '873 application) by Hess, et al. This device placed a cap over the service valve and secured the cap with a padlock. However, padlocks are easily broken by rotational torque or by other means. Because the '873 design relies solely on a padlock for security, the '873 design provides virtually no protection. Additionally, the design requires a collar on the propane tank and is therefore limited in use to only tanks with collars.

Therefore, what is needed is a safety device that universally fits standard propane tank service valves and protects the contents of the tank from theft or accidental leakage. The present invention fits all standard propane tank service valves. It is significantly smaller than the '873 device. It is easier to install than the '873 device and similar in installation to currently existing plugs. It is resistant to attack through cutting, rotational torque, prying or brute force. Finally, the present invention is a significant improvement over currently existing technology, as attested to by the fact that it has received immediate and wide-spread acceptance in the marketplace.

### SUMMARY OF THE INVENTION

According to the present invention, a propane tank safety device and a method are provided which permit service personnel or others to easily install the propane tank safety device on a propane tank having a standard gas valve. It is an object of the present invention to protect a propane tank valve in a manner that is cheaper and better than currently existing technology. In accordance with this object and with others which will be described and which will become apparent, an exemplary embodiment of propane tank safety device in accordance with the present invention comprises a safety device to prevent unauthorized access to a service valve of a propane tank.

In the preferred embodiment, the device includes a male protective cap and a female cap receiver that cooperate together to lock the outlet stem of the propane tank service valve. The protective cap comprises a stem and a dome. Housed within the protective cap is a lock such as a plug cylinder lock. The lock includes a latch that, in the extended and locked position, protrudes outwardly from the cap stem. The plug cylinder lock is not part of the invention. When installed over the receiver, the dome of the protective cap is shaped to completely cover a top surface of the receiver by way of a lip that longitudinally extends beyond the bottom surface of the protective cap, covering the top surface of the receiver and, in one embodiment, a portion of the outlet stem. The cap receiver has a bore opening to a top, an interior surface forming the walls of the bore, an exterior surface, the top and a bottom. It is generally cylindrical in shape and may taper slightly towards the bottom. The exterior surface can be threaded to match the ASME standard thread used in the outlet stem of a propane tank valve. In one embodiment, the interior surface of the receptor has a ridge extending radially towards the center of the bore to receive the latch of the plug lock housed within the stem of the protective cap. The outside edge of the top surface of the receiver may be shaped to receive a wrench.

In accordance with one aspect of the invention, a method is provided for use by propane tank service personnel to install a propane tank safety device in a propane tank service valve, the method comprising the steps of: connecting a propane tank safety device receiver to an outlet stem of a standard tank service valve by first screwing a propane tank safety device receiver bottom into the outlet stem of a standard tank service valve, the outlet stem having a threaded interior to receive the propane tank safety device receiver and the bore of the propane tank safety device receiver having a ridge that extends radially inward. The second step is to tighten the cap receiver tightly into place with a wrench or other tool. The third step is to insert a propane tank safety device protective cap stem first into the bore of the propane tank safety device receiver until a latch in the stem of the protective cap passes the ridge of the propane tank safety device receiver and a lip on the propane tank protective cap extends past and covers the top of the propane tank safety device receiver. Fourth, the latch is then extended manually or automatically by use of a spring-loaded latch so that longitudinal movement of the cap is blocked by cooperation between the latch and the receiver ridge. So installed, the cap may freely rotate within the receiver. So installed, the lip of the cap covers the top of the receiver and, in an alternative embodiment, the outside end of the outlet stem, thereby preventing access to the receiver and outlet stem. With the propane tank safety device in place, the safety device cannot be unscrewed, pried or pulled out.

Other features and advantages of the invention will be set forth in, or apparent from, the following detailed description of the preferred embodiment of the invention.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 illustrates a basic propane tank service valve.

FIG. 2 illustrates a basic embodiment of the propane tank locking device.

FIG. 3 illustrates a basic embodiment of a male protective cap portion of the propane tank locking device.

FIG. 4 illustrates a basic embodiment of a female receiver portion of the propane tank locking device.

FIG. 5 illustrates a basic embodiment of a receiver and a protective cap of the propane tank safety device fitting into a propane tank service valve.

### DETAILED DESCRIPTION

A propane tank safety device is described. In the following description, for the purposes of explanation, specific component arrangements, constructions and other details are set forth in order to provide a more thorough understanding of the present invention. It will be apparent to those skilled in the art, however, that the present invention may be practiced without these specific details. In some instances, well known manufacturing methods and structures have not been described in detail so as to refrain from unnecessarily obscuring the present invention.

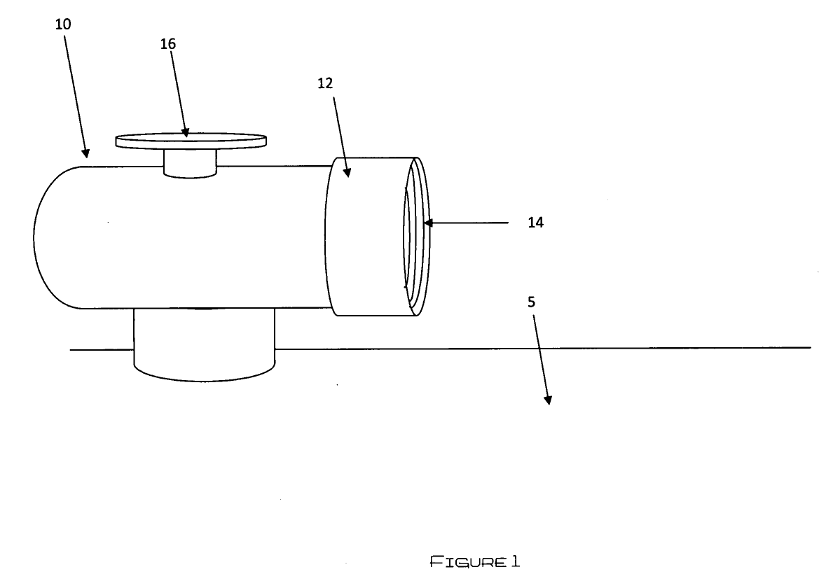

Referring first to FIG. 1, an exemplar propane tank service valve 10 is shown attached to a propane tank 5. Many propane tanks contain additional valves. The service valve 10 is a standard type. Because of the conventional nature thereof, the service valve 10 will be only briefly described. The service valve 10 and propane tank 5 are not part of the present invention. The service valve 10 includes an outlet stem 12. The outlet stem 12 includes a reverse-threaded longitudinally extending bore 14 that, when in use, engages a fill hose or appliance supply line (not shown) to supply propane gas to a downstream appliance. The service valve 10 has a handle 16 that rotates to open or close the valve 10 to supply or turn off propane to the downstream appliance.

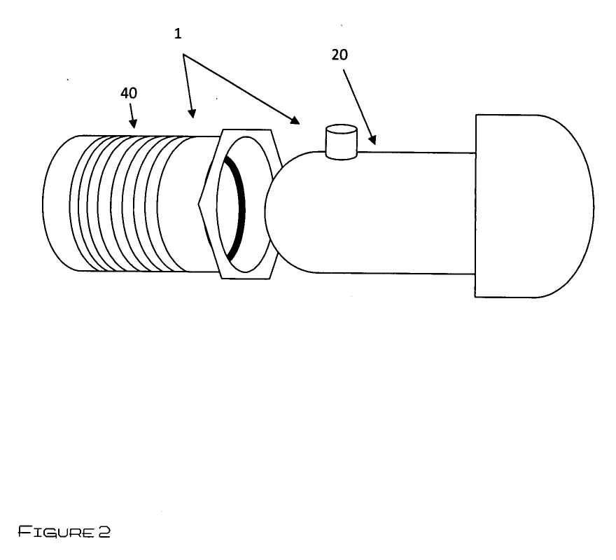

Referring next also to FIG. 2, the propane tank safety device, which is generally denoted 1, is designed to fit partially within the outlet stem 12 of the service valve 10 as described in detail immediately below. The propane tank safety device 1 of the current invention is comprised of a male protective cap, which is generally denoted 20, and a female receiver 40.

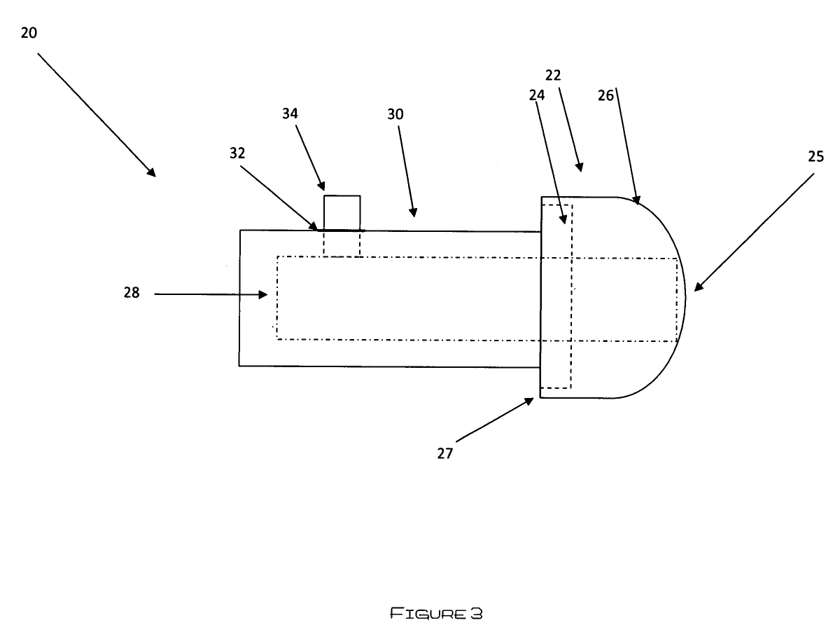

Referring next also to FIG. 3, the male protective cap 20 of the propane tank safety device 1 is shown. The protective cap 20 is comprised of a cap dome 22 and a cap stem 30. In one embodiment, the base of the dome 22 has a diameter sufficient to enclose a portion of the outlet stem 12 and the receiver 40. In an alternative embodiment, the base of the dome 22 has a diameter sufficient to enclose a portion of the receiver 40 only. In the preferred embodiment, the dome 22 comprises a semi-spherical top surface 24 and a flat bottom surface 26 having a longitudinally extending lip 27. The top surface 24 contains an opening 25 to receive a key. The lip 27 on the bottom surface 26 extends longitudinally downward from the bottom surface 26 and has a depth and diameter sufficient to enclose the top surface of the receiver 40. Housed within the dome 22 and stem 30 is a keyed plug cylinder lock 28.

The cap stem 30 is generally cylindrical in shape and is attached to the bottom surface 26 of the cap dome 22. The length of the cap stem 30 is less than the depth of the outlet stem 12. The diameter of the cap stem 30 is smaller than the internal diameter of the outlet stem 12. The cap stem 30 contains a stem hole 32. A latch 34 of the keyed plug cylinder lock 28 protrudes outwardly from the stem hole 32 when the keyed plug cylinder lock 28 is in a locked position. The latch 34 retracts into the stem 30 when the keyed plug cylinder lock 28 is in an unlocked position. The latch 34 may be spring-loaded or it may be operated manually with a key. However, the latch 34 is retracted into the stem 30 with a key.

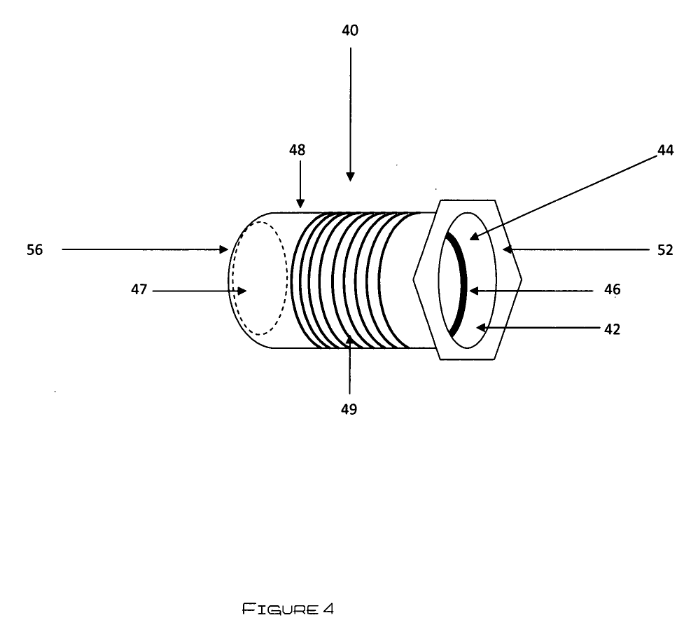

Referring next also to FIG. 4, an exemplary embodiment of the propane tank safety device receiver 40 is shown. The propane tank safety device receiver 40 is sized and shaped to partially fit within a standard gas valve outlet stem 12. The receiver 40 includes a longitudinally extending bore 42 therein opening to a top surface 52 and having a bore surface 44. The receiver 40 also includes an exterior surface 48 and a bottom surface 56. In the preferred embodiment, the bore surface 44 of the propane tank safety device receiver 40 contains a ridge 46 that radially extends latitudinally towards the center of the tank safety device receiver 40. The ridge 46 is large enough to block longitudinal movement of the latch 34 when the latch 34 is extended. When the protective cap 20 of the propane tank safety device 1 is fully inserted into the receiver 40 (as discussed more fully below), the latch 34 of the keyed plug cylinder lock 28 is positioned within the bore 42 between the ridge 46 and the bore bottom surface 47 of the receiver 40. The latch 34 is then either manually or automatically fully extended and may be retracted only with a key. With the latch 34 fully extended, cooperation between the ridge 46 of the receiver 40 and the latch 34 prevents the latch 34 from moving longitudinally within the receiver 40 and thereby prevents the propane tank safety device 1 from being withdrawn from the propane tank outlet stem 12. In an alternative embodiment, the ridge 46 is replaced by a groove cut within the bore surface 44. The grove is large and deep enough to receive the latch 34. With the latch 34 fully extended, cooperation between the groove and the latch 34 prevents the latch 34 from moving longitudinally within the receiver 40.

The exterior surface 48 of the receiver 40 is sized and shaped to screw into the outlet stem 12 of the propane tank service valve 10 and contains a reverse-threaded thread 49. In an alternative embodiment, the receiver 40 may be set into place within the outlet stem 12 by means other than screwing into the stem 12. The receiver 40 may be tapered near the receiver bottom 56 in order to better fit into an outlet stem 12. The outer perimeter of the receiver top surface 52 may be shaped to receive a wrench so that the receiver 40 can be firmly tightened into place.

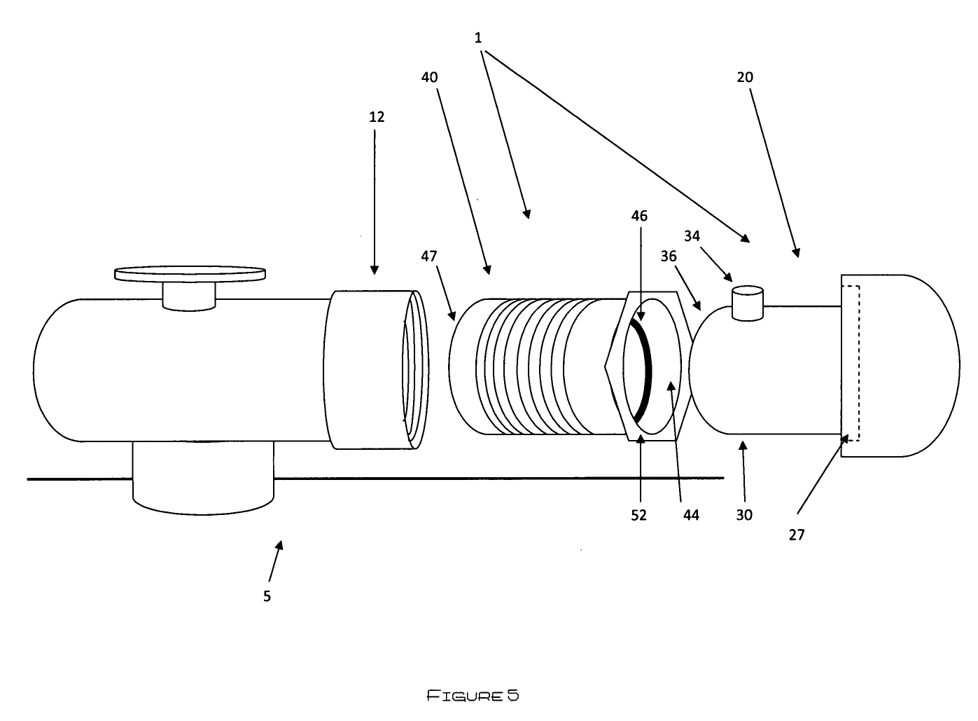

Referring now to FIGS. 1-5, the propane tank safety device 1 cooperates with the propane tank service valve outlet stem 12 to prevent access to the contents of a propane tank 5 by blocking and locking the propane tank service valve outlet stem 12. To install the safety device 1, first the device receiver 40 is screwed into the propane tank service valve outlet stem 12 until the propane tank safety device receiver 40 is in place partially within the propane tank service valve outlet stem 12. The receiver 40 may then be tightened firmly into place with a wrench or other such tool. Next, the propane tank safety device protective cap 20 is installed by pushing the cap stem 30 into the receiver bore 42 until the stem latch 34 is positioned past the receiver bore's ridge 46 and the bottom of the stem 36 is resting on or near the receiver bore's bottom surface 47. The propane tank safety device protective cap 20 is now in place. With the propane tank safety device protective cap 20 in place, the latch 34 is then extended nearly to the bore surface 44 either manually or by using a spring-loaded latch 34. With the propane tank safety device protective cap 20 so installed, the ridge 46 of the receiver 40 is positioned between the latch 34 and the top surface 52 of the receiver 40 and the latch 34 cannot move longitudinally past the ridge. With the ridge 46 restricting the longitudinal movement of the latch 34, the propane tank safety device 1 can only move rotationally. So positioned within the outlet stem 12, the device 1 can only be withdrawn from the propane tank service valve outlet stem 12 by first using a key to unlock the protective cap 20 and retract the latch 34 into the stem 30, then withdrawing the protective cap completely from the bore 42 by pulling it out from the receiver 40, uncovering the receiver 40. The receiver 40 can then be withdrawn by using a wrench to unscrew the receiver 40 from the propane tank outlet stem 12. Removing the receiver 40 unblocks the outlet stem 12.

When the device 1 is installed within the tank outlet stem 12, the cap dome lip 27 extends longitudinally away from the bottom surface 26 of the dome 22 and covers the outer edge of the top surface 52 of the propane tank safety device receiver 40. In an alternative embodiment, the lip 27 will also extend sufficiently to cover a portion of the propane tank service valve outlet stem 12. By covering the receiver 40, unauthorized personnel cannot cut, pry off or unscrew the device 1.

Finally, because the movement of the latch 34 is restricted only by the cooperation of the latch 34 with the bore ridge 46 or bore surface groove of the receiver 40, the propane tank safety device protective cap 20 may freely rotate while installed. This prevents the propane tank safety device protective cap 20 from being torn off through torque by a pipe wrench or other similar device.

There are several advantages to the design of the present invention. One advantage of the propane tank safety device 1 over prior art is that it is smaller and simpler. It is small enough to fit in the palm of a hand. Another advantage is that it is designed to universally fit the service valve of any standard propane tank. Because the lock is housed within the propane tank safety device protective cap 20, another advantage is that the propane tank safety device 1 is not subject to attack by attacking the lock. Another advantage is that propane tank safety device 1 cannot be broken by the application of torque.

Although the present invention has been described in terms of specific exemplary embodiments, it will be appreciated that various modifications and alterations might be made by those skilled in the art without departing from the spirit and scope of the invention. The presently disclosed embodiments are therefore to be considered in all respects as illustrative and not restrictive and all changes which come within the meaning and range of equivalency of the claims are therefore intended to be embraced therein.

What is claimed is:

1. A safety device for a valve such as can be found on a propane tank, the device comprising:
a protective cap and a cap receiver,
the protective cap housing a lock having a latch and further comprising a dome and a cap stem, and
the dome further comprising a top surface and a bottom surface; and
the cap stem affixed to the bottom surface of the dome, the cap stem further comprising an opening through which the latch can be extended and retracted; and
the receiver having a longitudinally extending bore therein and further comprising a top surface, an exterior surface, an interior surface forming the sides of the bore, and
the interior surface further comprising means for locking the protective cap into place in the receiver, wherein the locking means, in a locked position prevents longitudinal movement of the protective cap within the receiver, and
wherein the locking means includes the latch cooperating with the receiver, and
wherein the protective cap and receiver are installed in the valve and cooperate to block access to the contents of the tank through the valve.

2. The safety device as set forth in claim 1, wherein the receiver's exterior surface is threaded.

3. The safety device as set forth in claim 1, wherein the locking means comprises a ridge extending radially inward into the bore of the receiver.

4. The safety device as set forth in claim 1, wherein the locking means comprises a groove extending radially into the interior surface of the receiver and the groove is large and deep enough to receive the latch.

5. The safety device as set forth in claim 1, wherein the bottom surface of the protective cap's dome has a longitudinally extending lip.

6. The safety device as set forth in claim 5, wherein the lip has a depth and diameter sufficient to cover the top surface of the receiver.

7. The safety device as set forth in claim 5, wherein the lip has a depth and diameter sufficient to cover a portion of the valve

8. The safety device as set forth in claim 1, wherein the top surface of the protective cap's dome has an opening to receive a key.

9. A method of securing a tank, the tank having a valve that includes an outlet stem, the method comprising the steps of:
screwing a receiver into the outlet stem, the receiver having a longitudinally extending bore therein shaped to receive a protective cap and the longitudinally extending bore having means for locking the protective cap into place over the valve, wherein the locking means, in a locked position prevents longitudinal movement of the protective cap within the receiver; and
inserting the protective cap into the receiver, the protective cap including a latch capable of being extended or retracted, until the latch is moved past the locking means of the receiver; and
moving the latch to an extended position.

10. The method of claim 9 wherein the protective cap also includes a lip and the protective cap is inserted into the receiver until the lip sufficiently encloses a portion of the receiver.

11. The method of claim 11 wherein moving the latch to an extended position is done automatically by using a spring loaded latch.
